(19) United States
(12) Patent Application Publication
(10) Pub. No.: US 2020/0311627 A1
(43) Pub. Date: Oct. 1, 2020

(54) TRACKING DATA FLOWS IN AN ORGANIZATION

(71) Applicant: Microsoft Technology Licensing, LLC, Redmond, WA (US)

(72) Inventors: David James MARCOS, Bothell, WA (US); Ashutosh Raghavender CHICKERUR, Sammamish, WA (US); Leili POURNASSEH, Bellevue, WA (US); Piyush JOSHI, Redmond, WA (US); Pouyan AMINIAN, Seattle, WA (US)

(21) Appl. No.: 16/363,265

(22) Filed: Mar. 25, 2019

(51) Int. Cl. G06Q 10/06; G06F 21/62; G06F 16/908

(52) U.S. Cl. CPC G06Q 10/0633; G06Q 10/06393; G06F 16/908; G06F 21/6245; G06Q 10/0635

(57) ABSTRACT

Techniques for tracking data flows in an organization are provided. According to one set of embodiments, a computer system can receive a message indicating injection of an artificial data record (i.e., dye record) into a first data store of an organization, where the message includes a unique identifier associated with the artificial data record and an identifier of the first data store. The computer system can further scan a plurality of data stores of the organization for the unique identifier and, upon finding the unique identifier in a second data store of the organization that is different from the first data store, generate data flow information for the organization indicating a data flow from the first data store to the second data store and verify one or more policies of the organization based on the data flow information.

### BACKGROUND

Many organizations today employ multiple software systems that each generate, collect, and/or analyze data to support the organization's day-to-day operations. For example, an online retailer may employ a payment system that collects and maintains customer payment information (e.g., credit card number, billing address, etc.), an order management system that tracks the statuses and histories of customer orders, a customer relationship management (CRM) system that generates and stores customer shopping profiles, and so on.

In such organizations, it is fairly common for data to “flow” (i.e., be propagated, either in its original format or a modified/transformed format) from the data store of one system to the data stores of one or more other systems. For instance, in the online retailer example above, the CRM system may pull customer order data from a database owned by the order management system and store some or all of this data in a CRM database as part of the CRM system's customer shopping profiles.

With the emergence of data privacy laws as well as the rising prevalence of data breaches/cyber-attacks, it is becoming increasingly important for organizations to understand and keep track of these data flows for legal compliance and security reasons. This is particularly true for large organizations that generate/collect very large volumes of data and have complex interactions between a wide array of data stores/systems. However, there is currently no mechanism for achieving such data flow tracking in a structured and automated way.

### SUMMARY

Techniques for tracking data flows in an organization are provided. According to one set of embodiments, a computer system can receive a message indicating injection of an artificial data record (i.e., dye record) into a first data store of an organization, where the message includes a unique identifier associated with the artificial data record and an identifier of the first data store. The computer system can further scan a plurality of data stores of the organization for the unique identifier and, upon finding the unique identifier in a second data store of the organization that is different from the first data store, generate data flow information for the organization indicating a data flow from the first data store to the second data store and verify one or more policies of the organization based on the data flow information.

### BRIEF DESCRIPTION OF THE DRAWINGS

FIG. 1 depicts an architecture for tracking data flows in an organization according to certain embodiments.

FIG. 2 depicts a high-level data flow tracking workflow according to certain embodiments.

FIG. 3 depicts a flowchart for registering data stores in a data catalog according to certain embodiments.

FIG. 4 depicts a flowchart for injecting dye records according to certain embodiments.

FIG. 5 depicts a flowchart for performing data flow discovery based on injected dye records according to certain embodiments.

FIG. 6 depicts a flowchart for verifying organizational policies based on discovered data flows according to certain embodiments.

FIG. 7 depicts an example computer system according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details, or can be practiced with modifications or equivalents thereof.

### 1. Overview

Embodiments of the present disclosure are directed to techniques for tracking the flow of data between data stores in an organization. As used herein, a “data store” is any type of repository or data structure that can be used to hold data, such as a database table or group of database tables, a file or group of files, a key-value store, etc.

At a high level, these techniques involve (1) injecting artificial data records (referred to herein as “dye records”) into the organization's data stores, where each dye record is associated with a unique identifier (ID), and (2) periodically scanning all of the data stores to look for movement of the injected dye records, by virtue of their unique IDs, from their points of origin to other data stores over time. Based on (2), data flow information can be generated that provides an indication of how data is flowing through the organization (e.g., data records of type X are being propagated from data store D1 to data stores D2 and D3, data records of type Y are being propagated from data store D4 to data store D5, etc.) and this information can be leveraged in various ways.

For example, in one set of embodiments, the data flow information can be presented in a graphical form (e.g., as a data flow graph) to security or data privacy officers of the organization for review. In another set of embodiments, the data flow information can be fed into a policy engine that is configured with a number of organizational policies pertaining to data movement and/or data retention. The policy engine can automatically analyze the data flow information to determine if any of the policies have been violated and, if so, can take an appropriate action (e.g., generate an alert, restrict access to data that has violated a policy, encrypt the data, delete the data, etc.).

The foregoing and other aspects of the present disclosure are described in further detail in the sections that follow.

### 2. Architecture and High-Level Workflow

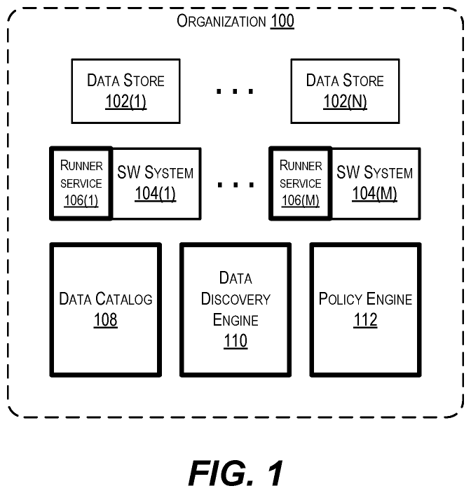

FIG. 1 is a simplified block diagram of a software architecture for tracking data flows in an organization 100 according to certain embodiments. Organization 100 (which may be, e.g., an enterprise, a government agency, an educational institution, etc.) comprises a number of data stores 102(1)-(N) that hold data generated/collected/used by the organization as part of its regular operations, as well as a number of software systems or services 104(1)-(M) that operate on the data in data stores 102(1)-(N). By way of example, software system 104(1) may be a logging system/service that creates and stores diagnostic logs in a set of log files 102(1), software system 104(2) may be a telemetry system/service that collects and maintains telemetry information in a telemetry database 102(2), software system 104(3) may be an analytics system/service that generates and stores business insights in an insights database 102(3), and so on.

As noted in the Background section, it is fairly common in organizations such as organization 100 for data to flow between the organization's data stores in order to realize various business objectives. For instance, the team responsible for software system 104(2) may determine that the system would benefit from data generated or collected by software system 104(1) in, e.g., data store 102(1) and thus replicate some or all of that data, either in its original format or a modified format, from data store 102(1) to a data store owned by system 104(2) (e.g., data store 102(2)). Similarly, the team responsible for software system 104(3) may determine that the system would benefit from data generated or collected by software system 104(2) in data store 102(2) (including the data copied from data store 102(1)) and thus replicate some or all of that data, either in its original format or a modified format, from data store 102(2) to a data store owned by system 104(3) (e.g., data store 102(3)).

The issue with this type of cross-store data movement is that it becomes very difficult to keep track of all of the organization's data flows, which has implications for data privacy and security. For example, in the scenario above where data is replicated from data store 102(1) of system 104(1) to data store 102(2) of system 104(2) and again to data store 102(3) of system 104(3), the original data in data store 102(1) may comprise personal, confidential, and/or otherwise sensitive data for one or more users. If those users did not provide informed consent with regards to the use or access of that data by downstream systems 102(2) or 102(3), this data flow may represent a violation of one or more data privacy laws that apply to the organization.

As another example, if the original data in data store 102(1) is subject to a security policy indicating that the data must be encrypted at all times, that data may be unintentionally transformed and stored in unencrypted form in data store 102(3), resulting in a potential security vulnerability that can be exploited by attackers. More broadly, if the original data in data store 102(1) is created/collected there under the scope of a particular data management policy but is subsequently propagated to one or more other data stores, there is no guarantee that the same data management policy will be applied to that data in the downstream data stores. This is particularly problematic in organizations where each software system 104 and corresponding data store(s) 102 are owned/maintained by a different team, since there is no single individual or team that has a holistic understanding of how data is flowing throughout the organization.

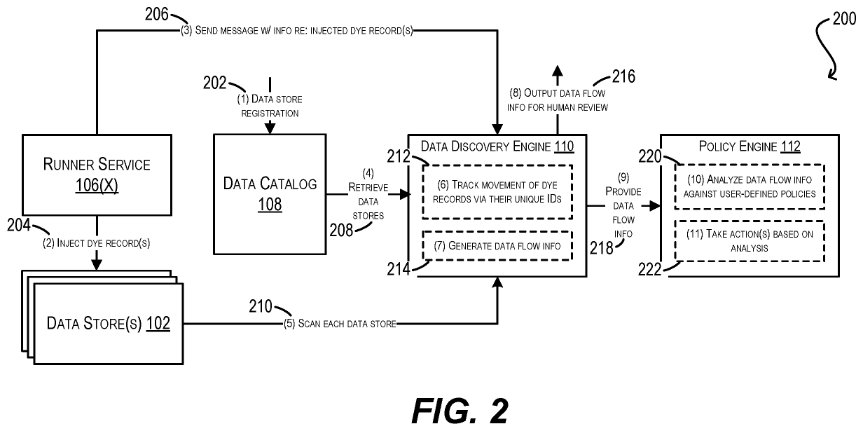

To address these and other similar issues, the software architecture shown in FIG. 1 implements four novel components: a per-system runner service 106, a data catalog 108, a data discovery engine 110, and a policy engine 112. Taken together, components 106-112 enable organization 100 to automatically track all of the data flowing between its data stores (and in some cases, automatically act upon this data flow information) in a structured, accurate, and efficient manner. A high-level workflow 200 that can be executed by these components in accordance with certain embodiments is shown in FIG. 2.

Starting with step (1) of workflow 200 (reference numeral 202), the owners of each data store 102 can register metadata regarding the data store, such as data store name/ID, description, network location/address, etc. in data catalog 108 and grant data discovery engine 110 read access to the data store. This step may be performed, e.g., at the time the data store is first created or brought online and ensures that data catalog 108 has knowledge of, and data discovery engine 110 is able to read, every data store in the organization.

Concurrently with or subsequent to step (1), each runner service 106(X) associated with a corresponding software system 104(X) can, on a periodic or on-demand basis, create (or in other words, “inject”) an artificial data record (i.e., dye record) into one or more data stores 102 owned/managed by software system 104(X) (step (2), reference numeral 204). This dye record is “artificial” in the sense that it does not contain actual data created or collected by software system 104(X) as part of its normal operation; instead, the dye record is associated with a unique identifier (ID) and its purpose is to act as a marker that can be tracked (via the unique ID) as it flows from its point of origin (i.e., the data store where it is originally injected) to other data stores. Thus, these dye records are conceptually similar to a tracking dye that is injected into the bloodstream of an individual to track the flow of blood from the injection site and through the individual's body.

In addition to injecting the dye record, at step (3) (reference numeral 206) each runner service 106(X) can communicate a message to data discovery engine 110 that includes information regarding the injected dye record (e.g., the dye record's unique ID, the data store into which the dye record was injected, a timestamp indicating the time at which the injection occurred, etc.). Data discovery engine 110 can keep track of this dye record information in an internal dye record repository.

Concurrently with or subsequent to steps (2) and (3), data discovery engine 110 can, on a periodic basis, retrieve a list of the data stores registered in data catalog 108 (step (4), reference numeral 208), scan (i.e., read) the data in each data store (step (5), reference numeral 210), and track the presence/movement of the dye records injected by runner services 106(1)-(M) based on their respective unique IDs (step (6), reference numeral 212).

For example, if a dye record with ID 9A92DX2 was originally injected by runner service 106(1) of software system 104(1) into data store 102(1) at time T1, data discovery engine 110 can check whether ID 9A92DX2 appears in any other data store after time T1. If so, data discovery engine 110 can determine that the dye record, as well as potentially other data records of the same type, have flowed from origin data store 102(1) to those other data stores where the ID is found. On the other hand, if ID 9A92DX2 does not appear in any other data store, data discovery engine 110 can determine that the dye record has remained stationary at the origin data store.

Based on the scanning and dye record tracking at steps (5) and (6), data discovery engine 110 can generate data flow information indicating the data flows it has found across data stores 102(1)-(N) at step (7) (reference numeral 214). Data discovery engine 110 can then output this data flow information in some human-readable format (e.g., a data flow graph) (step (8), reference numeral 216), and/or provide the data flow information as input to policy engine 112 (step (9), reference numeral 218).

In the case where data discovery engine 110 provides the data flow information to policy engine 112, policy engine 112 can analyze the received information against one or more user-defined policies governing data movement and/or data retention within organization 100 (step (10), reference numeral 220). Finally, at step (11) (reference numeral 222), policy engine 112 can take one or more appropriate actions based on its analysis (e.g., generate an alert indicating that a policy has been violated, restrict access, encrypt, or delete data that has violated a policy, etc.). For example, if policy engine 112 is configured with a policy indicating that customer credit card information should not be replicated outside of data store D1 but, as part of its analysis at step (10), determines that such credit card information has in fact flowed from D1 to a different data store D2, policy engine 112 can raise an alert identifying this policy violation, which can be reviewed and acted upon by officers of the organization. The alert can include the rogue data element(s) (e.g., the credit card information in D2) as well as where the data flowed from (e.g., D1) in order to aid in the investigation of its lineage.

The remaining sections of this disclosure provide additional details regarding possible implementations for data catalog 108, runner service 106, data discovery service 110, and policy engine 112. It should be appreciated that the software architecture of FIG. 1 and high-level workflow 200 of FIG. 2 are illustrative and not intended to limit embodiments of the present disclosure. For example, depending on the implementation, the organization of components 106-112 and the mapping of functions to these components can differ.

Further, although workflow 200 is depicted as a linear workflow with a starting point and an ending point, the steps performed by runner services 106(1)-(M), data discovery engine 110, and policy engine 112 can be performed concurrently or in an overlapping fashion, and the entire workflow may be repeated on an ongoing basis or over some predefined time interval (e.g., 30 days). One of ordinary skill in the art will recognize other variations, modifications, and alternatives.

### 3. Data Catalog Registration

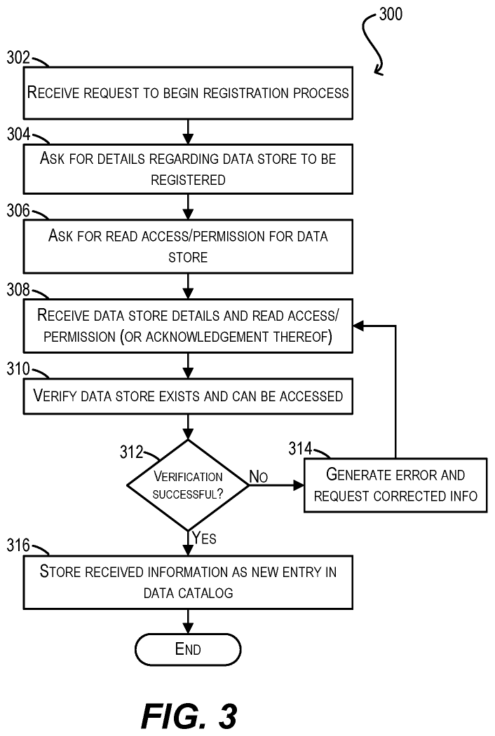

FIG. 3 is a flowchart 300 that depicts the process of registering a data store 102 within data catalog 108 (per step (1) of high-level workflow 200) according to certain embodiments.

Starting with block 302, data catalog 108 (or a control component thereof) can receive a request to begin the registration process. In one set of embodiments, this request may be initiated manually by a human user via some user interface (e.g., a web-based self-service portal). Alternatively, this request may be generated automatically by, e.g., an automated agent or system. For example, in one embodiment, the request may be automatically generated by a centralized data management system whenever a new data store is defined or deployed within organization 100.

At block 304, data catalog 108 can ask for details regarding the data store to be registered, such as data store ID or name, a brief description, and the data store's network location/address. Data catalog 108 can also ask for access credentials or authorization/permission that will enable data discovery engine 110 to read from the data store (block 306). In the scenario where the registration process is initiated by an automated agent/system, the automated agent/system may provide this information as part of the initial request and thus steps 304 and 306 can be omitted.

At block 308, data catalog 108 can receive from the request originator the requested data store details and access credentials/authorization (or an acknowledgment thereof). For example, if the data store is a relational database that is secured via a sign on-based system, data catalog 108 may receive a login name and password that allows for read access. As another example, if the data store is a file, data catalog 108 may receive an acknowledgment that data discovery engine 110 has been granted file system-level read permission for the file.

At blocks 310 and 312, upon receiving the data store details and access credentials/authorization, data catalog 108 can attempt to verify that the data store exists and can be accessed. If this verification fails, data catalog 108 can generate an error message indicating that one or more of the provided details are invalid and request corrected information (block 314).

Finally at block 316, data catalog 108 can store the received information as a new data store entry within the catalog and workflow 300 can end.

### 4. Dye Record Injection

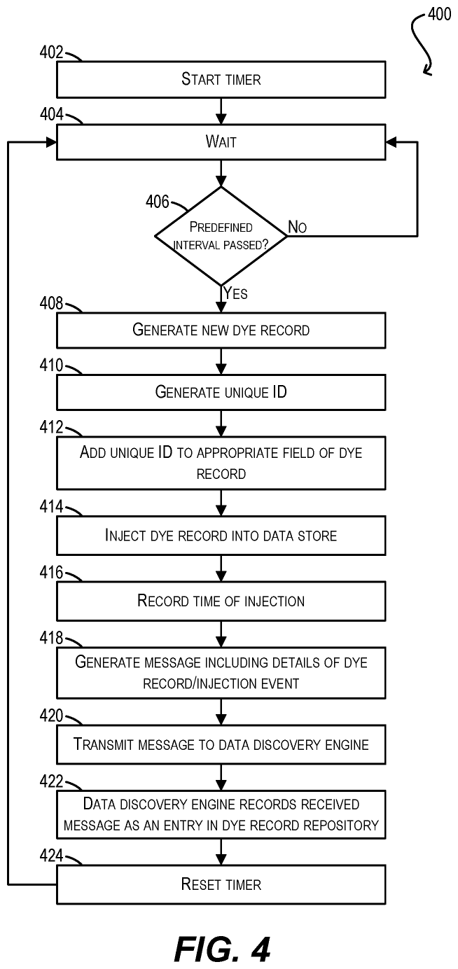

FIG. 4 is a flowchart 400 that depicts the process of injecting, by a given runner service 106, a dye record into a data store 102 (per steps (2) and (3) of high-level workflow 200) according to certain embodiments. As mentioned previously, a dye record is an artificial data record that is associated with a unique ID and is created for the purpose of tracking the movement of data of that type from its point of origin/injection to other data stores in an organization.

In various embodiments, the specific nature/format of the dye record will depend on the nature of the data store that is being injected. For example, if the data store being injected is a database table, the dye record may be a new data row in the table with a unique ID in a key field of the table. Alternatively, if the data store being injected is a group or directory of files, the dye record may be a new file with a unique ID included in the file name. In various embodiments, it is assumed that the developers/administrators of each software system 104(X) will implement corresponding runner service 106(X) and will configure the runner service in a manner that ensures it creates dye records in a format that is appropriate for the data store(s) of that system.

Turning now to workflow 400, at blocks 402-406 runner service 106 can initiate a timer and wait until a predefined time interval I1 (reflecting the desired interval between dye record injections) has passed. Once interval I1 has passed, runner service 106 can generate a new dye record corresponding to the type of data maintained by data store 102 (e.g., a database row, a file, etc.) (block 408), generate a unique ID (block 410), and add the unique ID to an appropriate field or attribute of the dye record (block 412). In certain embodiments, this unique ID may be randomly-generated from a sufficiently large identity space (e.g., 128 bits) to ensure uniqueness of the ID. In other embodiments, the ID may be generated based on some predefined order, either by runner service 106 or by data discovery engine 110. For example, in one embodiment data discovery engine 110 can assign a range of IDs for use by runner service 106 and runner service 106 can generate dye record IDs from this assigned range in a sequential manner. Alternatively, at the time of generating a new dye record, runner service 106 can request an ID from data discovery engine 110, which can generate the ID and provide it to runner service 106. In some embodiments, the ID can be generated based on the data store into which the dye record will be injected (and/or the software system which owns that data store). For example, if the dye record will be injected into data store D1 owned by software system S1, a portion of the generated ID can indicate an association with data store D1 and/or system S1. This aids in downstream analysis since the origin of the dye record can be determined from its identifier.

At blocks 414 and 416, runner service 106 can write/inject the generated dye record into data store 102 and record the time of injection. Further, runner service 106 can generate a message for data discovery engine 110 that includes details regarding the dye record/injection event such as the dye record's unique ID, the ID/name of data store 102, the time of injection, etc. (block 418) and transmit this message to engine 110 (block 420). In response, data discovery engine 110 can extract the dye record information and record it as a dye record entry in an internal repository (block 422).

Finally at block 424, runner service 106 can reset its timer and return to the wait loop at blocks 404/406. The entire process can then repeat once time interval I1 has passed again, and this can continue until runner service 106 is disabled/terminated.

It should be noted that, rather than performing dye record injection at predetermined time intervals as shown in flowchart 400, in some embodiments each runner service 106 can instead perform this injection on-demand in response to commands received from data discovery engine 110. This allows data discovery engine 110 to control the rate at which dye records are created and thus reduces the likelihood of dye record ID collisions, as well as facilitates targeted data flow tracking (for example, data discovery service 110 may wish to track data injected by a particular runner service 106(X) over one time window, data injected by another runner service 106(Y) another time window, and so on).

Further, although not shown in flowchart 400, in certain embodiments data discovery engine 110 can automatically age-out older dye record entries from its internal repository as it adds new entries at block 422. This prevents the total number of dye record entries in the repository from growing too large, which may overwhelm engine 110 over time. The specific rules used to govern this age-out process can differ depending on the implementation; for example, in one embodiment data discovery engine 110 can age-out dye record entries that have been injected into a given data store D if (1) the record is older than X days or months and (2) there is at least one newer dye record that has been injected into data store D since that original record.

### 5. Data Flow Discovery

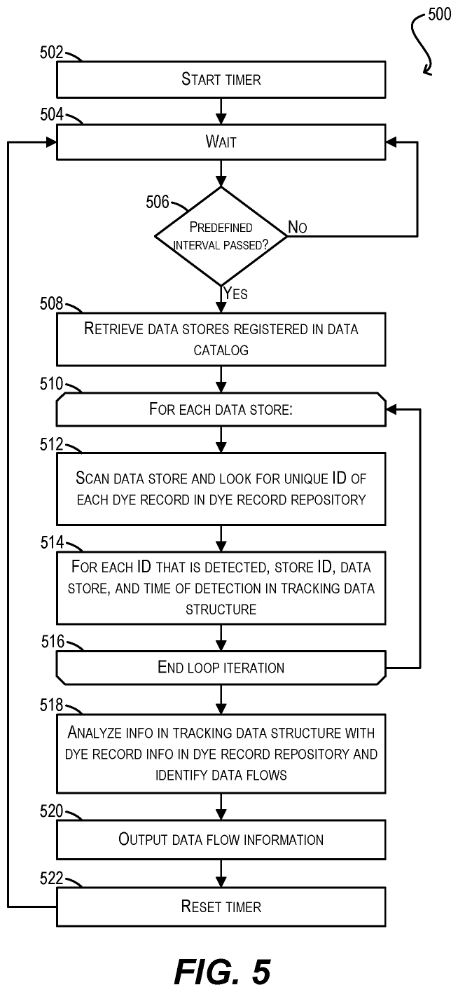

FIG. 5 is a flowchart 500 that may be performed by data discovery engine 110 for discovering data flows and generating data flow information (per steps (4)-(6) of high-level workflow 200) based on the dye records injected by runner services 106(1)-(M) according to certain embodiments.

Starting with blocks 502-506, data discovery engine 110 can initiate a timer and wait until a predefined time interval I2 (reflecting the desired interval between processing runs for data discovery engine 110) has passed. Once I2 has passed, data discovery engine 110 can retrieve a list of the data stores registered in data catalog 108 (block 508) can enter a loop that iterates through each data store (block 510).

Within the loop, data discovery engine 110 can scan (i.e., read) the data content of the current data store and look for the unique ID of each dye record stored in its internal dye record repository (block 512). For example, if the current data store is a database table, data discovery engine 110 can look for the ID of each dye record in any of the rows of the database table. As another example, if the current data store is a file, data discovery engine 110 can look for the ID of each dye record in any of the metadata fields or in the data content of the file. For each dye record ID that is detected, data discovery engine 110 can make a note of the detected ID, the current data store, and the current time in a tracking data structure (block 514). Data discovery engine 110 can then reach the end of the current loop iteration (block 516) and return to the top of the loop if there are additional data stores to be scanned.

Once all of the data stores in data catalog 108 have been scanned, the tracking data structure maintained by data discovery engine 110 will identify all instances where dye records IDs have been found. Accordingly, at block 518, data discovery engine 110 can analyze the information in the tracking data structure in conjunction with the dye record injection information in its dye record repository to identify the data flows in the organization. For instance, if the dye record repository indicates that dye record R1 was injected in data store D1 at time T1 and the tracking data structure indicates that dye record R1 was subsequently detected in data store D2 at time T2, data discovery engine 110 can conclude that dye record R1 (as well as potentially other data records of the same type) have flowed from D1 to D2.

Finally at blocks 520 and 522, data discovery engine 110 can output the data flow information, reset its timer, and return to the wait loop at blocks 504/506. The entire process can then repeat once time interval I2 has passed again, and this can continue until data discovery engine 110 is disabled/terminated.

As mentioned previously, in one set of embodiments data discovery engine 110 can output the data flow information in a format that is appropriate for human review (e.g., a data flow graph). In addition to or in lieu of this, data discovery engine 110 can submit the data flow information to policy engine 112 for automated analysis. In this latter case, the submitted data flow information may be formatted according to any structured data format that is understood by policy engine 112, such as XML (Extensible Markup Language), JSON (JavaScript Object Notation), or the like.

### 6. Policy Verification

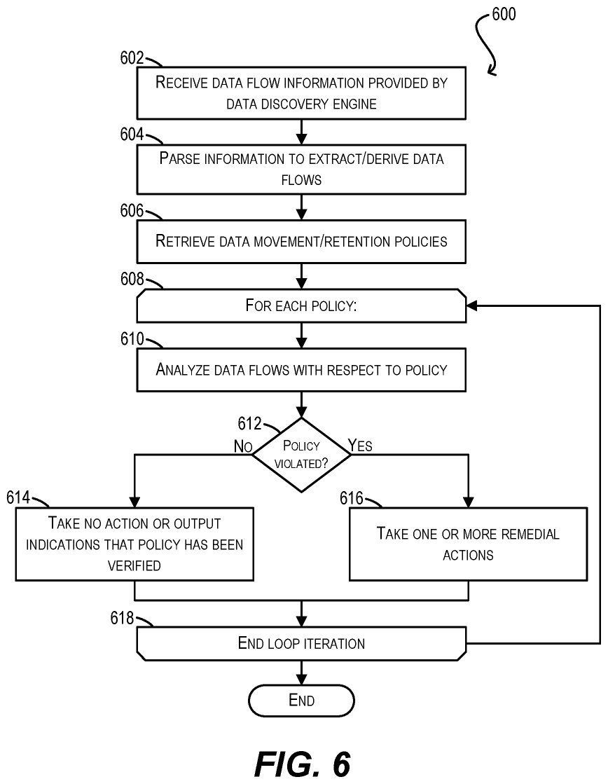

FIG. 6 is a flowchart 600 that may be performed by policy engine 112 for verifying organizational policies based on the data flow information generated by data discovery engine 110 (per steps (10) and (11) of high-level workflow 200) according to certain embodiments.

At blocks 602 and 604, policy engine 112 can receive the data flow information provided by data discovery engine 110 and can parse this information to extract/derive the data flows represented therein. In addition, at block 606, policy engine 112 can retrieve policies that have been defined for the organization with respect to, e.g., the movement or retention of data. For example, one such policy may indicate that all customer credit card records must be encrypted at all times and must not be retained for longer than one month. Another such policy may indicate that data cannot flow from a particular data store D1 to another particular data store D2. These policies may be manually defined by one or more users (e.g., a data privacy or security officer) or may be automatically generated by, e.g., a policy management system.

At block 608, policy engine 112 can enter a loop for each retrieved policy. Within this loop, policy engine 112 can analyze the extracted/derived data flows with respect to the current policy (block 610) and determine if the policy is being followed or has been violated (block 612). If the policy is being followed, policy engine 112 can take no action or can output an indication that the policy has been verified (block 614). On the other hand, if the policy has been violated, policy engine 112 can take one or more remedial actions (block 616). In one set of embodiments, these remedial actions can include restricting access to data that has violated a policy (e.g., data that has flowed to one or more invalid data stores). These restrictions can comprise, e.g., preventing the software systems of the organization from reading such data from the invalid data stores. In another set of embodiments, the remedial actions can include applying an explicit retention policy to the data so that it will be automatically deleted from the invalid data stores after a set period of time. In yet another set of embodiments, the remedial actions can include automatically encrypting or deleting the data in the invalid data stores. In yet another set of embodiments, the remedial actions can include raising an alert indicating the policy violation. This alert can identify, e.g., the policy that has been violated, the data elements that have violated the policy, and/or the lineage of those data elements (i.e., where the data elements originated from).

Policy engine 112 can then reach the end of the current loop iteration (block 618) and repeat the loop as needed. Once all policies have been processed, the flowchart can end.

### 7. Example Computer System

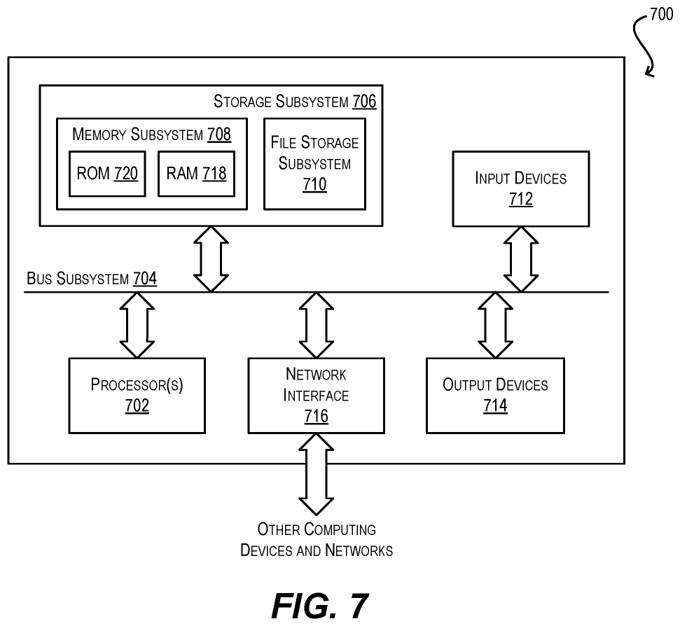

FIG. 7 is a simplified block diagram illustrating the architecture of an example computer system 700 according to certain embodiments. Computer system 700 (and/or equivalent systems/devices) may be used to run any of the software components described in the foregoing disclosure, including components 106-112 of FIG. 1. As shown in FIG. 7, computer system 700 includes one or more processors 702 that communicate with a number of peripheral devices via a bus subsystem 704. These peripheral devices include a storage subsystem 706 (comprising a memory subsystem 708 and a file storage subsystem 710), user interface input devices 712, user interface output devices 714, and a network interface subsystem 716.

Bus subsystem 704 can provide a mechanism for letting the various components and subsystems of computer system 700 communicate with each other as intended. Although bus subsystem 704 is shown schematically as a single bus, alternative embodiments of the bus subsystem can utilize multiple buses.

Network interface subsystem 716 can serve as an interface for communicating data between computer system 700 and other computer systems or networks. Embodiments of network interface subsystem 716 can include, e.g., an Ethernet module, a Wi-Fi and/or cellular connectivity module, and/or the like.

User interface input devices 712 can include a keyboard, pointing devices (e.g., mouse, trackball, touchpad, etc.), a touch-screen incorporated into a display, audio input devices (e.g., voice recognition systems, microphones, etc.), motion-based controllers, and other types of input devices. In general, use of the term “input device” is intended to include all possible types of devices and mechanisms for inputting information into computer system 700.

User interface output devices 714 can include a display subsystem and non-visual output devices such as audio output devices, etc. The display subsystem can be, e.g., a transparent or non-transparent display screen such as a liquid crystal display (LCD) or organic light-emitting diode (OLED) display that is capable of presenting 2D and/or 3D imagery. In general, use of the term “output device” is intended to include all possible types of devices and mechanisms for outputting information from computer system 700.

Storage subsystem 706 includes a memory subsystem 708 and a file/disk storage subsystem 710. Subsystems 708 and 710 represent non-transitory computer-readable storage media that can store program code and/or data that provide the functionality of embodiments of the present disclosure.

Memory subsystem 708 includes a number of memories including a main random access memory (RAM) 718 for storage of instructions and data during program execution and a read-only memory (ROM) 720 in which fixed instructions are stored. File storage subsystem 710 can provide persistent (i.e., non-volatile) storage for program and data files, and can include a magnetic or solid-state hard disk drive, an optical drive along with associated removable media (e.g., CD-ROM, DVD, Blu-Ray, etc.), a removable or non-removable flash memory-based drive, and/or other types of non-volatile storage media known in the art.

It should be appreciated that computer system 700 is illustrative and other configurations having more or fewer components than computer system 700 are possible.

The above description illustrates various embodiments of the present disclosure along with examples of how aspects of these embodiments may be implemented. The above examples and embodiments should not be deemed to be the only embodiments, and are presented to illustrate the flexibility and advantages of the present disclosure as defined by the following claims. For example, although certain embodiments have been described with respect to particular process flows and steps, it should be apparent to those skilled in the art that the scope of the present disclosure is not strictly limited to the described flows and steps. Steps described as sequential may be executed in parallel, order of steps may be varied, and steps may be modified, combined, added, or omitted. As another example, although certain embodiments have been described using a particular combination of hardware and software, it should be recognized that other combinations of hardware and software are possible, and that specific operations described as being implemented in software can also be implemented in hardware and vice versa.

The specification and drawings are, accordingly, to be regarded in an illustrative rather than restrictive sense. Other arrangements, embodiments, implementations and equivalents will be evident to those skilled in the art and may be employed without departing from the spirit and scope of the present disclosure as set forth in the following claims.

What is claimed is:

1. A computer system comprising:
a processor; and
a computer readable storage medium having stored thereon program code that, when executed by the processor, causes the processor to:
receive a message indicating injection of an artificial data record into a first data store of an organization, the message including a unique identifier associated with the artificial data record and an identifier of the first data store;
scan a plurality of data stores of the organization for the unique identifier associated with the artificial data record;
upon finding the unique identifier in a second data store of the organization that is different from the first data store, generate data flow information for the organization indicating a data flow from the first data store to the second data store; and
verify one or more policies of the organization based on the data flow information.

2. The computer system of claim 1 wherein the message is received from a runner service associated with a software system of the organization, the runner service being configured to inject artificial data records into the first data store on a periodic basis.

3. The computer system of claim 2 wherein the first data store is owned by the software system.

4. The computer system of claim 1 wherein the plurality of data stores are registered in a data catalog.

5. The computer system of claim 4 wherein prior to scanning the plurality of data stores, the program code causes the processor to retrieve metadata regarding the plurality of data stores from the data catalog.

6. The computer system of claim 4 wherein when each data store is registered in the data catalog, the computer system is granted read access to the data store.

7. The computer system of claim 1 wherein the message further includes a timestamp indicating a time of the injection.

8. The computer system of claim 1 wherein the scanning is performed on a periodic basis.

9. The computer system of claim 1 wherein the program code further causes the processor to:
output the data flow information in a human-readable format.

10. The computer system of claim 9 wherein the human-readable format is a data flow graph.

11. The computer system of claim 1 wherein the one or more policies include policies pertaining to data movement or data retention.

12. The computer system of claim 1 wherein the program code that causes the processor to verify the one or more policies comprises program code that causes the processor to:
parse the data flow information to identify the data flow from the first data store to the second data store; and
for each of the one or more policies:
analyze the data flow with respect to the policy to determine if the policy has been violated.

13. The computer system of claim 12 wherein if the processor determines that a policy in the one or more policies has been violated, the program code further causes the processor to take one or more remedial actions.

14. The computer system of claim 13 wherein the one or more remedial actions include generating an alert indicating the policy violation, restricting access to data involved in the policy violation, encrypting the data involved in the policy violation, or deleting the data involved in the policy violation.

15. A method comprising:
receiving, by a computer system, a message indicating injection of an artificial data record into a first data store of an organization, the message including a unique identifier associated with the artificial data record and an identifier of the first data store;
scanning, by the computer system, a plurality of data stores of the organization for the unique identifier associated with the artificial data record;
upon finding the unique identifier in a second data store of the organization that is different from the first data store, generating, by the computer system, data flow information for the organization indicating a data flow from the first data store to the second data store; and
verifying, by the computer system, one or more policies of the organization based on the data flow information.

16. The method of claim 15 further comprising outputting the data flow information in a human-readable format.

17. The method of claim 15 wherein if the computer system determines that a policy in the one or more policies has been violated, the method further comprises generating an alert indicating the policy violation, restricting access to data involved in the policy violation, encrypting the data involved in the policy violation, or deleting the data involved in the policy violation.

18. A computer readable storage medium having stored thereon program code executable by a computer system, the program code causing the computer system to:
receive a message indicating injection of an artificial data record into a first data store of an organization, the message including a unique identifier associated with the artificial data record and an identifier of the first data store;
scan a plurality of data stores of the organization for the unique identifier associated with the artificial data record;
upon finding the unique identifier in a second data store of the organization that is different from the first data store, generate data flow information for the organization indicating a data flow from the first data store to the second data store; and
verify one or more policies of the organization based on the data flow information.

19. The computer readable storage medium of claim 18 wherein the program code further causes the computer system to:
output the data flow information in a human-readable format.

20. The computer readable storage medium of claim 18 wherein if the computer system determines that a policy in the one or more policies has been violated, the program code further causes the computer system to generate an alert indicating the policy violation, restrict access to data involved in the policy violation, encrypt the data involved in the policy violation, or delete the data involved in the policy violation.
